(19) United States
(12) Patent Application Publication
(10) Pub. No.: US 2024/0038270 A1
(43) Pub. Date: Feb. 1, 2024

(54) VIDEO SEARCH APPARATUS, VIDEO SEARCH METHOD, AND STORAGE MEDIUM

(71) Applicant: NEC Corporation, Tokyo (JP)

(72) Inventor: Haruna Watanabe, Tokyo (JP)

(73) Assignee: NEC Corporation, Tokyo (JP)

(21) Appl. No.: 18/222,818

(22) Filed: Jul. 17, 2023

(30) Foreign Application Priority Data
Jul. 27, 2022 (JP) 2022-119678

(51) Int. Cl. G11B 27/00; G11B 27/34

(52) U.S. Cl. CPC G11B 27/002; G11B 27/34

(57) ABSTRACT

A video search apparatus 100 according to the present disclosure includes a search unit 121 configured to use scene information including event information including a plurality of events constituting a video scene and time information indicating a time set for the video scene to set a search range of an event in a target video image based on the time information and also search for the event included in the event information from the target video image within the set search range, and a determination unit 122 configured to determine a video section in the target video image that corresponds to the scene information targeted for the search based on a result of the search for the event.

### CROSS-REFERENCE TO RELATED APPLICATIONS

This application is based upon and claims the benefit of priority from Japanese Patent Application No. 2022-119678, filed on Jul. 27, 2022, the disclosure of which is incorporated herein in its entirety by reference.

### TECHNICAL FIELD

The present disclosure relates to a video search apparatus, a video search method, and a storage medium.

### BACKGROUND ART

Patent Literature 1 discusses one example of a video search system that searches for a scene constituted by a plurality of events from a video image. In this video search system, first, a video image targeted for a search is indexed with structural indexes, which are assigned by dividing the video image into structural units prepared as a plurality of hierarchized sections, and the structural units are set so as to be used as a search granularity, which is a range when a scene is searched for. Then, the video image is further indexed with event indexes, which indicate events that have occurred in the video image. For example, in a case of a video image of a baseball game, the video image from a game start is divided into respective structural units hierarchized in ranks of “inning”, “top/bottom”, “batting”, and “pitching”, and these structural units are assigned as the structural indexes. Further, event indexes for identifying the contents of events are assigned to scenes such as a “hit” and “run scoring” in the video image. In addition thereto, in the video search system discussed in Patent Literature 1, for some video scene, a term expressing the content of the video scene, a state transition pattern constituted by a pattern of occurrence of a plurality of events corresponding to the video scene, and the search granularity indicating the structural unit targeted for the search when the video scene is searched for are set in association with one another in advance. This means that, for example, in the case of the video image of the baseball game, a pattern of occurrence of events “hit” and “run scoring” is set as the state transition pattern and “batting” is set as the structural unit used as the search granularity with respect to a video scene “run-scoring hit”.

Then, in the video search system discussed in Patent Literature 1, when a search is conducted, a term expressing a desired video scene is input, and the state transition pattern, i.e., the pattern of occurrence of events corresponding to the input term is searched for unit by unit according to the search granularity, i.e., the structural unit corresponding to the input term, based on the assumption that the video image is structured in the above-described manner. Then, the structural unit in the video image in which the state transition pattern is searched for is output as a search result. This means that, for example, when the search for the video scene “run-scoring hit” from the video image of the baseball game is attempted as described above, the pattern of occurrence of events “hit” and “run scoring” is searched for from the video image indexed with the structural indexes unit by unit set according to the search granularity corresponding to the video scene “run-scoring hit”, i.e., the structural unit “batting”. Then, if events of a hit and run scoring subsequent thereto are searched for in some batting in the video image, the video image of this batting is output as the “run-scoring hit”, which is the desired video scene.

### CITATION LIST

### Patent Literature

### [Patent Literature 1] Japanese Patent Application Laid-Open No. 2001-92849

### SUMMARY OF INVENTION

### Technical Problem

However, the above-described technique discussed in Patent Literature 1 is constructed assuming that the video image targeted for the search is indexed with the above-described structural indexes in advance, and a search range in the entire video image is defined to be a predetermined structural unit accordingly. Therefore, this technique raises a problem of taking labor and cost to index the video image with the structural indexes in advance.

On the other hand, the absence of the structural indexes assigned to the video image makes it impossible to appropriately determine the section of the desired video scene. For example, when the search for the video scene “run-scoring hit” from the baseball video image is attempted as described above, information specifying what time one inning or one batting turn starts and ends cannot be acquired from the video image, and an appropriate search range cannot be set. Therefore, for example, a combination of a hit event in the top of the first inning and a run-scoring event in the bottom of the third inning is inadvertently determined to be the desired video scene “run-scoring hit”, and a video section from the hit in the top of the first inning to the run-scoring in the bottom of the third inning is incorrectly determined as one video scene. In other words, a problem occurs in that, although a “run-scoring hit” never exists across innings, such an inappropriate video scene may be undesirably searched for, and the section of the desired video scene cannot be appropriately determined.

In light thereof, an object of the present disclosure is to provide a video search apparatus capable of solving the incapability of appropriately determining a section of a desired video scene from a video image, which is the above-described problem.

### Solution to Problem

A video search apparatus according to one aspect of the present disclosure is configured to include
a search unit configured to use scene information including event information including a plurality of events constituting a video scene and time information indicating a time set for the video scene to set a search range of an event in a target video image based on the time information and also search for the event included in the event information from the target video image within the set search range, and
a determination unit configured to determine a video section in the target video image that corresponds to the scene information targeted for the search based on a result of the search for the event.

Further, a video search method according to one aspect of the present disclosure is configured to include
using scene information including event information including a plurality of events constituting a video scene and time information indicating a time set for the video scene to set a search range of an event in a target video image based on the time information and also search for the event included in the event information from the target video image within the set search range, and
determining a video section in the target video image that corresponds to the scene information targeted for the search based on a result of the search for the event.

Further, a program according to one aspect of the present disclosure is configured to cause a computer to execute processing to
use scene information including event information including a plurality of events constituting a video scene and time information indicating a time set for the video scene to set a search range of an event in a target video image based on the time information and also search for the event included in the event information from the target video image within the set search range, and
determine a video section in the target video image that corresponds to the scene information targeted for the search based on a result of the search for the event.

### Advantageous Effects of Invention

By being configured in the above-described manner, the present disclosure allows the video section of the desired video scene to be appropriately determined from the video image.

### BRIEF DESCRIPTION OF DRAWINGS

FIG. 1 is a block diagram illustrating the configuration of a video search apparatus according to a first exemplary embodiment of the present disclosure.

FIG. 2 is a diagram illustrating examples of a scene condition table stored in the video search apparatus disclosed in FIG. 1.

FIG. 3 is a diagram illustrating how processing for searching for a video scene is performed by the video search apparatus disclosed in FIG. 1.

FIG. 4 is a diagram illustrating how the processing for searching for a video scene is performed by the video search apparatus disclosed in FIG. 1.

FIG. 5 is a diagram illustrating how the processing for searching for a video scene is performed by the video search apparatus disclosed in FIG. 1.

FIG. 6 is a diagram illustrating how the processing for searching for a video scene is performed by the video search apparatus disclosed in FIG. 1.

FIG. 7 is a flowchart illustrating the operation of the video search apparatus disclosed in FIG. 1.

FIG. 8 is a block diagram illustrating the hardware configuration of a video search apparatus according to a third exemplary embodiment of the present disclosure.

FIG. 9 is a block diagram illustrating the configuration of the video search apparatus according to the third exemplary embodiment of the present disclosure.

### DESCRIPTION OF EMBODIMENTS

### First Exemplary Embodiment

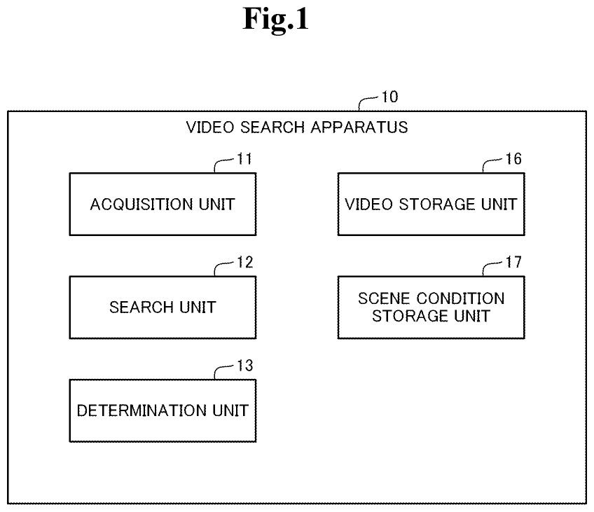

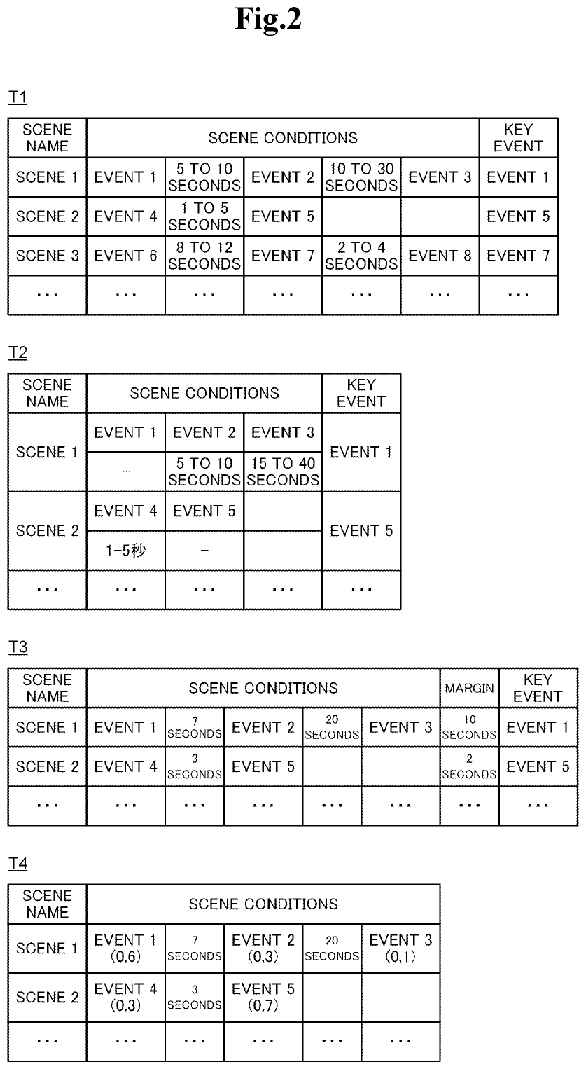

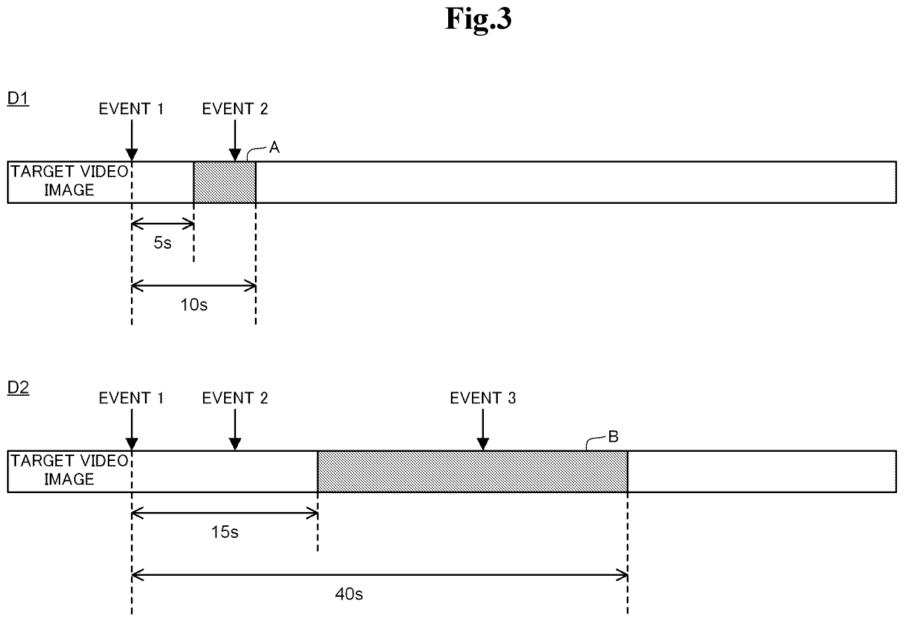

A first exemplary embodiment of the present disclosure will be described with reference to FIGS. 1 to 7. FIGS. 1 and 2 are diagrams for illustrating the configuration of a video search apparatus, and FIGS. 3 to 7 are diagrams for illustrating processing operations of the video search apparatus.

### [Configuration]

A video search apparatus 10 according to the present exemplary embodiment is configured to detect a section corresponding to a desired video scene constituted by a plurality of events from a target video image, and determine and output this video section. As one example, the present exemplary embodiment will be described referring to an example in which the video search apparatus 10 sets a video image of a baseball game as the target video image, and searches for a video scene such as a “run-scoring hit” (a batter makes a hit and a run is scored) from this target video image and determines and outputs the video section thereof. Further, in the present exemplary embodiment, the video search apparatus 10 also calculates reliability of the determined video section as a content indicating the “run-scoring hit”, i.e., a degree indicating credibility that the determined video section is the “run-scoring hit”. However, the target video image handled by the video search apparatus 10 may be a video image having any content without being limited to a baseball game, and a searched video scene may also be a video scene having any content.

The video search apparatus 10 is configured of one or a plurality of information processing apparatus(es) each including an arithmetic unit and a storage unit. Then, as illustrated in FIG. 1, the video search apparatus 10 includes an acquisition unit 11, a search unit 12, and a determination unit 13. Each of the functions of the acquisition unit 11, the search unit 12, and the determination unit 13 can be realized through execution of a program for realizing each of the functions that is stored in the storage unit by the arithmetic unit. Further, the video search apparatus 10 includes a video storage unit 16 and a scene condition storage unit 17. The video storage unit 16 and the scene condition storage unit 17 are configured of the storage unit. Hereinafter, each configuration will be described in detail.

The video storage unit 16 stores therein the target video image, which is set as a target searched for a video scene. For example, the target video image is a video image of a baseball game as described above, and is a video image captured in a baseball field and edited. Then, the target video image is assumed to be indexed in advance with an event index, which is information indicating an event that has occurred in the video image. As will be used herein, the “event” may be, for example, something expressing a person or an object appearing in the video image (for example, a “player”, a “spectator”, and a “scoreboard” in the case of the baseball video image), or may be something expressing an action of a person or an object (“throw a ball”, “run”, and “swing a bat”). Alternatively, the “event” may be, for example, a motion of a camera that captures this video image (for example, “pan” and “tilt”) or a feature of the edited video image (a “caption indicating the score” and “the camera is switched”).

In this case, the event index is assigned to a predetermined time in the target video image, and “time information” is associated with the “event”. Therefore, the event index is assumed to have no temporal duration. Note that the “time information” may be any information as long as it is information indicating a position in the temporal direction in the target video image, and may be information such as a clock time itself, a time elapsed from the beginning of the video image, or a frame number.

The scene condition storage unit 17 stores therein a scene condition table (scene information), which is information used when a video scene is searched for. The scene condition table is information that defines the video scene, and includes a “scene name” and “scene conditions” as mainly illustrated in FIG. 2.

Then, the “scene name” may be a name according to the content of the video scene (“hit” or “strikeout” in the case of the baseball video image), or may be a numerical number or an alphabet for identifying the scene. Note that a “query”, which is information for specifying the video scene to be searched for, is input by a searcher who requests the search for the video scene, and the “scene name” is constituted by information linkable with the “query”, as will be described below. Due to that, the scene condition table of the corresponding “scene name” is expected to be identified based on the “query” input from the searcher as a search request at the time of the search.

Further, the “scene conditions” include “event information” including an event constituting the video scene, and “time information indicating a time set for the video scene. Especially, in the present exemplary embodiment, the “event information” in the scene conditions is expressed by a series of a plurality of events for which an occurrence order is set. Further, in the present exemplary embodiment, the “time information” in the scene conditions indicates a time interval between the series of events for which the occurrence order is set, and, as one example, is expressed by a time interval from some specific event (a key event) to each of the other events or a time interval between events adjacent to each other in the occurrence order.

Now, specific examples of the above-described “scene conditions” will be described. In a case where the video scene is a “hit” in baseball, such a video scene is characterized by a sequence of three events “pitching”, “batting”, and “arrival of a batter at the first base”, and therefore the three events “pitching”, “batting”, and “arrival of a batter at the first base” are set as an event sequence indicating that these events occur in this order as the “event information” in the “scene conditions” of the scene name “hit”. Then, respective time intervals from the event “pitching” serving as the starting point to the other events “batting” and “arrival of a batter at the first base” are set as the “time information” in the “scene conditions” by way of example. In this case, the event “pitching” serving as the starting point will be referred to as the “key event”, and the other events “batting” and “arrival of a batter at the first base” will be referred to as “auxiliary events”. Alternatively, as another example of the “time information” in the “scene conditions”, each time interval between events adjacent to each other in the occurrence order may be set, and, in this case, the time interval between the event “pitching” and the event “batting” and the time interval between the event “batting” and the event “arrival of a batter at the first base” may be set.

However, the “time information” included in the “scene conditions” is not necessarily limited to the time interval between events like the above-described examples, and may be any information indicating a time settable for the video scene. For example, the “time information” may be the time length of the entire sequence that can contain the plurality of events constituting the video scene, or may be information such as a time ratio to the entire target video image. Further, the “time interval” and the “time information” may be any information as long as they are information indicating a time range in the temporal direction in the video image, and may be information such as a time length or a frame duration.

Specific examples of the data structure of the above-described scene condition table will be described with reference to FIG. 2. First, for a “scene 1” in a scene condition table indicated by a reference sign T1 in FIG. 2, occurrence of three events, an “event 1”, an “event 2”, and an “event 3” in this order is set as the “scene conditions”, and, for example, the time interval between events adjacent to each other, i.e., the time interval between the event 1 and the event 2 and the time interval between the event 2 and the event 3 are set to “5 to 10 seconds” and “10 to 30 seconds”, respectively. Further, the “key event” is set in the scene condition table indicated by the reference sign T1 in addition to the “scene name” and the “scene conditions”. The “key event” refers to one of events present in the scene conditions that is specified as a key from which the search begins. Note that, in this example, the time interval is set in the form of a range defined by a pair of maximum and minimum values as described above.

On the other hand, for the “scene 1” in a scene condition table indicated by a reference sign T2 in FIG. 2, the occurrence of the three events, the “event 1”, the “event 2”, and the “event 3” in this order is set as the “scene conditions”, and the “event 1” is set as the “key event”. Then, in this scene condition table, the time interval from the key event to each of the other events is set as the time interval between events. More specifically, the time interval between the event 1 and the event 2 and the time interval between the event 1 and the event 3 are set to “5 to 10 seconds” and “15 to 40 seconds”, respectively.

On the other hand, for the “scene 1” in a scene condition table indicated by a reference sign T3 in FIG. 2, the occurrence of the three events, the “event 1”, the “event 2”, and the “event 3” in this order is set as the “scene conditions”. The “event 1” is set as the “key event”. Further, each time interval between events, i.e., the time interval between the event 1 and the event 2 and the time interval between the event 2 and the event 3 are set to “7 seconds” and “20 seconds”, respectively. In addition thereto, a margin for each time interval between events, i.e., a time length by which the time interval set with respect to each interval between events can be extended or shortened is set in the scene condition table indicated by the reference sign T3. In this manner, the time interval may be set in the form of a fixed value for each interval between events and a margin common among all the intervals between events.

On the other hand, for the “scene 1” in a scene condition table indicated by a reference sign T4 in FIG. 2, the occurrence of the three events, the “event 1”, the “event 2”, and the “event 3” in this order is set as the “scene conditions”, and each time interval between events, i.e., the time interval between the event 1 and the event 2 and the time interval between the event 2 and the event 3 are set to “7 seconds” and “20 seconds”, respectively. However, the “key event” is not set in this table unlike the above-described tables. Instead, a “weight” is set for each event in the scene condition table indicated by the reference sign T4, and the most heavily weighted event may be treated as the “key event”. For example, for the “scene 1”, a weight “0.6”, a weight “0.3”, and a weight “0.1” are set for the “event 1”, the “event 2”, and the “event 3”, respectively, and the “event 1” may be treated as the key event. However, both the key event and the weight may be set in the scene condition table. Note that a value written as the weight in this case can be defined based on, for example, a frequency at which each event has occurred in previous data. A specific example of the definition method will be described. First, candidates for events characterizing some video scene are selected, and the numbers of times that these events are contained in a corresponding scene in previous data are counted. Then, the Softmax function is applied to the respective numbers of times of the events, and values adjusted in such a manner that the sum of them matches 1 are set as the respective weights of the events. However, the weights determined by the above-described method may be further manually adjusted, or the weights may be entirely manually defined without use of the above-described method. Note that, if neither the key event nor the weight is defined in the scene condition table, the first event or the last event in the event sequence may be treated as the key event, or an event randomly selected from the event sequence may be treated as the key event.

In this manner, the video search apparatus 10 stores the target video image and the scene condition table therein in advance. Then, the video search apparatus 10 searches for the requested video scene from the target video image using functions of the configuration that will be described now.

The acquisition unit 11 receives an input of the query, which is information about the video scene requested to be searched for, and acquires the scene condition table corresponding to the query from the scene condition storage unit 17. Assume that the query is, for example, information constituted by the scene name or an identification number for identifying the scene, and corresponding to the “scene name” in the scene condition table. As one example, when receiving an input of a query “hit”, the acquisition unit 11 acquires the scene condition table of the scene name “hit” corresponding to the query from the scene condition storage unit 17.

The search unit 12 uses the scene condition table acquired by the acquisition unit 11 and searches for an event contained in this scene condition table from the target video image stored in the video storage unit 16. At this time, while setting a search range of the event in the target video image using the time information such as the time interval between events contained in the scene condition table, the search unit 12 searches for the event according to the set occurrence order within this search range. In other words, the search unit 12 first searches for a predetermined event among the plurality of events contained in the scene condition table from the target video image, and sets the time interval from the searched predetermined event that is set with respect to another event as the search range in the target video image and then searches for the other event from the target video image within this search range after that. At this time, if the time interval set in the scene condition table is the time interval in relation to the key event, the search unit 12 sets the search range from the key event based on the time interval set with respect to each of the other events and searches for each of the events within this search range after searching for the key event. Alternatively, if the time interval set in the scene condition table is the time interval between events adjacent to each other in the occurrence order, the search unit 12 repeatedly sets the search range based on the time interval set with respect to each event preceding or subsequent to the predetermined event in the order and searches for each of the other events within this search range every time the predetermined event is searched for.

This means that, for example, when the query is “hit” as described above, the search unit 12 acquires the scene condition table of the scene name “hit” and searches for the three events “pitching”, “batting”, and “arrival of a batter at the first base” set in the scene conditions according to this occurrence order. Suppose that, at this time, the event “pitching” is set as the key event, and the time intervals from the key event are set for the other events “batting” and “arrival of a batter at the first base”, respectively. In this case, the search unit 12 first searches for the key event “pitching” from the target video image. Then, the search unit 12 searches for the event “batting” from the target video image within the time interval set for the event “batting” subsequent in the occurrence order from the time of the searched key event “pitching” as the search range. Further, the search unit 12 searches for the event “arrival of a batter at the first base” from the target video image within the time interval set for the event “arrival of a batter at the first base” further subsequent in the occurrence order from the time of the key event “pitching” as the search range.

Now, specifically how the search unit 12 performs the processing for searching for the event in the scene condition table like the examples illustrated in FIG. 2 will be described with reference to FIGS. 3 to 6. First, processing in the case of the scene condition table of the “scene 1” illustrated in the reference sign T2 in FIG. 2 will be described with reference to FIG. 3. As illustrated in a reference sign D1 in FIG. 3, the search unit 12 first searches for the key event “event 1” from the target video image. Then, the search unit 12 sets the time interval “5 to 10 seconds” from the key event that is set for the auxiliary event “event 2” subsequent in the occurrence order from the time of the searched key event “event 1” as a next search range A, and searches for the subsequent auxiliary event “event 2” from the target video image within this search range A. In this case, a position separated backward from the position of the event 1 by 5 seconds and a position separated from the position of the event 1 by 10 seconds are set as the beginning and the termination of the search range A, respectively. Then, after searching for the subsequent auxiliary event “event 2” from this search range A, the search unit 12 sets the time interval “15 to seconds” from the key event that is set for the auxiliary event “event 3” further subsequent in the occurrence order as a further next search range B as illustrated in a reference sign D2, and searches for the further subsequent auxiliary event “event 3” from the target video image within this search range B. In this case, a position separated backward from the position of the event 1 by 15 seconds and a position separated from the position of the event 1 by 40 seconds are set as the beginning and the termination of the search range B, respectively.

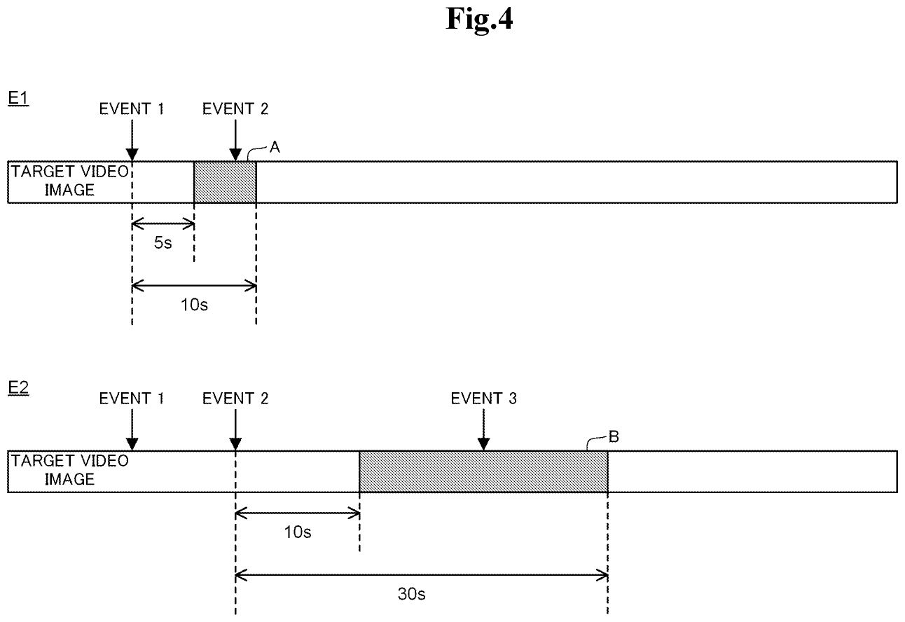

Next, the processing by the search unit 12 in the case of the scene condition table of the “scene 1” illustrated in the reference sign T1 in FIG. 2 will be described with reference to FIG. 4. As illustrated in a reference sign E1 in FIG. 4, the search unit 12 first searches for the key event “event 1” from the target video image. Then, the search unit 12 sets the time interval “5 to 10 seconds” from the event 1 that is set for the auxiliary event “event 2” subsequent in the occurrence order and adjacent to the event 1 from the time of the searched key event “event 1” as the next search range A, and searches for the subsequent auxiliary event “event 2” from the target video image within this search range A. In this case, the position separated backward from the position of the event 1 by 5 seconds and the position separated from the position of the event 1 by 10 seconds are set as the beginning and the termination of the search range A, respectively. Then, after searching for the subsequent auxiliary event “event 2” from this search range A, the search unit 12 sets the time interval “10 to 30 seconds” from the event 2 that is set for the auxiliary event “event 3” further subsequent in the occurrence order and adjacent to the event 2 as the further next search range B as illustrated in a reference sign E2, and searches for the further subsequent auxiliary event “event 3” from the target video image within this search range B. In this case, a position separated backward from the position of the event 2 by 10 seconds and a position separated from the position of the event 3 by 30 seconds are set as the beginning and the termination of the search range B, respectively.

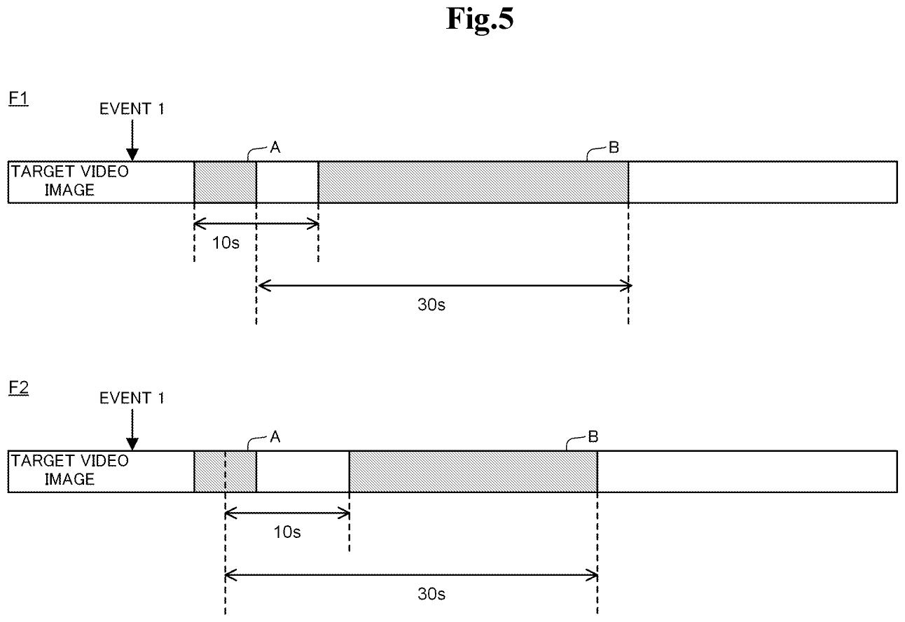

Note that the search unit 12 may set the search range B of the further subsequent auxiliary event “event 3” and search for the “event 3” as illustrated in FIG. 5, if the above-described search for the “event 2” results in a failure to find this “event 2”. As one example, as illustrated in a reference sign F1, the search unit 12 sets a position separated backward from the beginning of the search range A of the event 2 by 10 seconds, which is set as the minimum time interval between the event 2 and the event 3, as the beginning of the search range B of the event 3. Then, the search unit 12 sets a position separated backward from the termination of the search range A of the event 2 by 30 seconds, which is set as the maximum time interval between the event 2 and the event 3, as the termination of the search range B of the event 3. The range set in this manner is used as the search range B of the event 3. Alternatively, as another example, as illustrated in a reference sign F2, the search unit 12 may employ the time at the center of the search range A of the event 2 as a reference, and set the time interval “10 to 30 seconds” between the event 2 and the event 3 backward from this reference as the search range B of the event 3.

On the other hand, if the “margin” is set as the time interval as illustrated in the reference sign T3 in FIG. 2, the search unit 12 may set the search range by extending the time length thereof within the range of this “margin” and search for the event within the extended search range when the intended event cannot be searched for in the search range set in the above-described manner. Note that the search unit 12 may shorten the search range within the range of the “margin”.

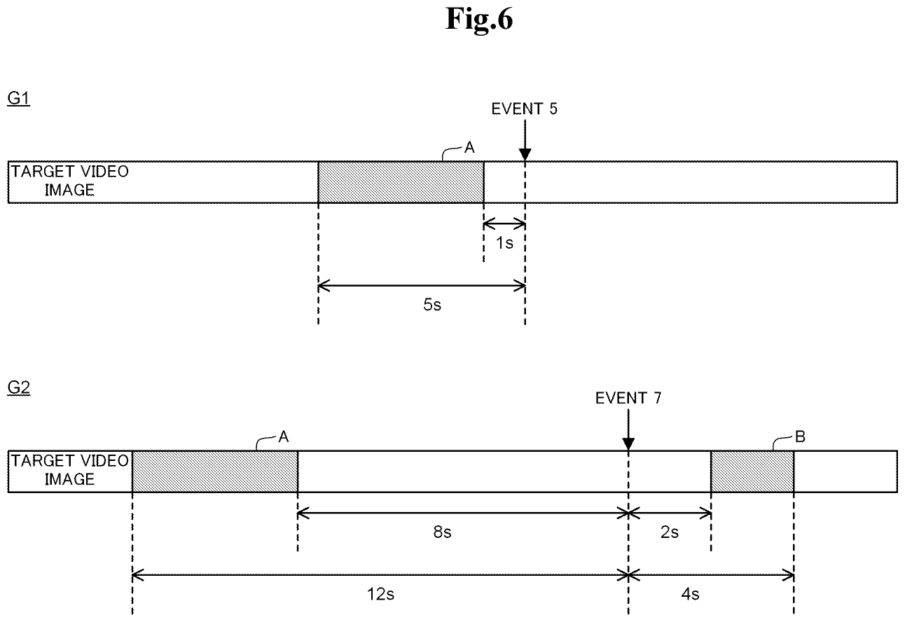

Further, if an auxiliary event is present prior to the key event like scenes 2 and 3 in the reference sign T1 in FIG. 2, the search unit 12 is expected to set the search range in the following manner. In the example of the “scene 2” in the reference sign T1 in FIG. 2, an auxiliary event “event 4” is set as a preceding event in the occurrence order with a time interval “1 to 5 seconds” in relation to a key event “event 5”. In this case, the search unit 12 first searches for the key event “event 5” from the target video image as illustrated in a reference sign G1 in FIG. 6. Then, the search unit 12 sets a range earlier than the time of the searched key event “event 5” by the time interval “1 to 5 seconds” from the event 5 that is set for the auxiliary event “event 4” preceding in the occurrence order and adjacent to the event 5 as the next search range A, and searches for the preceding auxiliary event “event 4” from the target video image within this search range A.

On the other hand, for the “scene 3” in the reference sign T1 in FIG. 2, an auxiliary event “event 6” is set as a preceding event in the occurrence order with a time interval “8 to 12 seconds” in relation to a key event “event 7”, and, further, an auxiliary event “event 8” is set as a subsequent event in the occurrence order with a time interval “2 to 4 seconds” in relation to the key event “event 7”. In this case, the search unit 12 first searches for the key event “event 7” from the target video image as illustrated in a reference sign G2 in FIG. 6. Then, the search unit 12 sets a range earlier than the time of the searched key event “event 7” by the time interval “8 to 12 seconds” from the event 7 that is set for the auxiliary event “event 6” preceding in the occurrence order and adjacent to the event 7 as the next search range A, and searches for the preceding auxiliary event “event 6” from the target video image within this search range A. Similarly, the search unit 12 sets a range later than the time of the searched key event “event 7” by the time interval “2 to 4 seconds” from the event 7 that is set for the auxiliary event “event 8” subsequent in the occurrence order and adjacent to the event 7 as the further next search range B, and searches for the preceding auxiliary event “event 8” from the target video image within this search range B. Note that the search unit 12 may set any of the search ranges A and B first, and may set any of the auxiliary events 6 and 8 first.

On the other hand, if the key event is not set in the scene condition table, the search unit 12 may set the key event based on the “weight” set as illustrated in the reference sign T4 in FIG. 2 and search for the event from this key event in the above-described manner. Alternatively, the search unit 12 may select the key event randomly from the plurality of events contained in the scene condition table and search for the event from this key event in the above-described manner.

On the other hand, if just a time length is set as the time information in the scene condition table differently from the time interval between events like the above-described example, the search unit 12 may set this time length as the search range and search for the event. For example, if the time length of the entire event sequence is set as the time information in the scene condition table, the search unit 12 may set a range of the set time length from the key event or an arbitrary event as the search range and search for all the events. On the other hand, if the ratio of the time of the entire event sequence to the entire target video image is set as the time information in the scene condition table, the search unit 12 may set a range of the set time length from the key event or an arbitrary event as the search range and search for all the events.

The determination unit 13 determines a video section in the target video image that corresponds to the scene condition table targeted for the search based on the result of the event search by the search unit 12. For example, if the video scene is constituted by the event sequence having the occurrence order of “the event 1, the event 2, and the event 3”, and all the events can be searched for, the determination unit 13 determines and outputs a video section from the position of the first event 1 to the position of the last event 3 in the target video image as the searched video scene. At this time, the determination unit 13 may identify and output the times or the frame numbers of the corresponding beginning and termination in the target video image or may identify and output the video data itself corresponding to this section as the video section.

However, the determination unit 13 may determine the video section based on the time information in the scene condition table such as the time interval between events in addition to the searched events. For example, supposing that the “event 1” and the “event 2” can be searched for but the “event 3” cannot be searched for as illustrated in the reference sign E2 in FIG. 4 when the “scene 1” in the reference sign T1 in FIG. 2 is searched for, an example in this case will be described now. In this case, the determination unit 13 may determine a range from the position of the “event 1” to the termination of the “search range B” of the “event 3” in the target video image as the video section. At this time, if the “margin” is set in the scene condition table as illustrated in the reference sign T3 in FIG. 2, the determination unit 13 may add a time length corresponding to this margin and determine this range as the video section. On the other hand, if the “event 1” can be searched for but the “event 2” cannot be searched for, and the search range B of the “event 3” further subsequent thereto is set and the “event 3” can be searched for as illustrated in the reference signs F1 and F2 in FIG. 5, the determination unit 13 may determine a range from the position of the “event 1” to the position of the “event 3” in the target video image as the video section. In other words, the determination unit 13 may determine a range between the successfully searched events at the both ends in the event sequence set in the scene condition table as the video section. Therefore, if the event 3 cannot be searched for in the event sequence of the above-described events 1, 2, and 3, the determination unit 13 may determine the range from the event 1 to the event 2 as a video portion.

Moreover, the determination unit 13 further calculates reliability of the determined video portion and outputs it together with the video portion. More specifically, the determination unit 13 calculates the reliability based on the events set in the scene condition table targeted for the search and the searched events. Now, the reliability is defined to be a value reflecting the credibility that the video scene constituted by the successfully searched events is the requested desired video scene, and is defined in such a manner that a higher value indicates higher credibility that the video scene is the desired video scene. For example, if N events are set in the scene condition table and n events among them can be searched for in the target video image, the reliability may be calculated as n/N. In other words, the reliability may be calculated in such a manner that the value of the reliability increases as the number of searched events increases among the events set in the scene condition table. Alternatively, for example, if the weight is written for each of the events set in the scene condition table, the weights of the successfully searched events in the target video image may be added up and calculated as the reliability. However, the determination unit 13 does not necessarily have to calculate the reliability.

### [Operation]

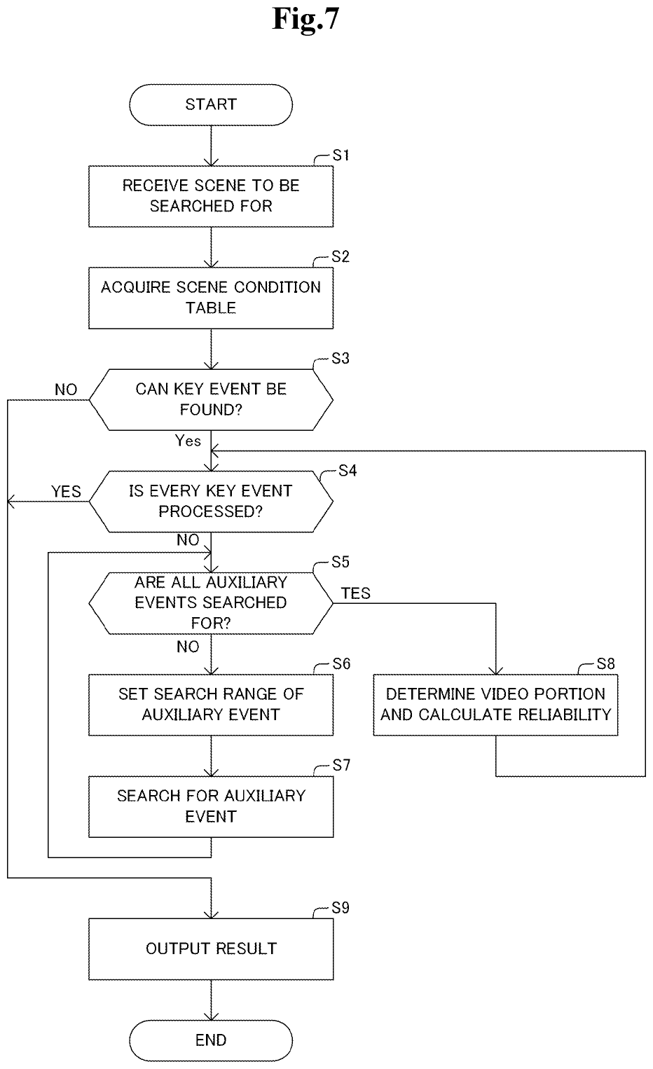

Next, the operation of the above-described video search apparatus 10 will be described mainly with reference to a flowchart illustrated in FIG. 7. Note that the video search apparatus 10 is assumed to store the above-described target video image and scene condition table therein in advance.

The video search apparatus 10 receives the input of the query as the information about the video scene requested to be searched for from a not-illustrated input device (step S1). Note that the video search apparatus 10 may acquire the target video image together with the query. Then, the video search apparatus 10 acquires the scene condition table corresponding to the query for the video scene from the scene condition storage unit 17 (step S2).

Subsequently, the video search apparatus 10 searches for the preset key event or the key event determined by any method in the event sequence contained in the acquired scene condition table from the target video image (step S3). At this time, if the key event cannot be found in the target video image (step S3: NO), the video search apparatus 10 outputs that the desired video scene cannot be found to an output device (step S9). If one or more key events can be found in the video image (step S3: YES), the video search apparatus 10 determines whether the processing for searching for the auxiliary events is performed with respect to every key event found in the target video image (step S4).

If the processing for searching for the auxiliary events is not performed with respect to every key event found in the target video image (step S4: NO), the video search apparatus 10 determines whether all of the auxiliary events contained in the scene condition table are searched for with respect to one of the key event(s) in the target video image on which the processing for searching for the auxiliary events is not performed (step S5).

If all of the auxiliary events contained in the scene condition table are not searched for (step S5: NO), the video search apparatus 10 sets the search range for the auxiliary event that is not searched for yet (step S6), and searches for the auxiliary event in the target video image within this search range (step S7).

If the search for all of the auxiliary events contained in the scene condition table is ended with respect to one of the key event(s) found in the video image (step S5: YES), the video search apparatus 10 determines the video section based on the result of the search for the auxiliary events and calculates the reliability of this video section (step S8). If the processing for searching for the auxiliary events is ended with respect to every key event found in the target video image (step S4: YES), the video search apparatus 10 outputs a search result constituted by the determined video section and reliability to the output device (step S9).

In this manner, the video search apparatus 10 according to the present exemplary embodiment sets the search range of the event using the time information set in the scene condition table, thereby being able to search for the plurality of events constituting the desired video scene with an appropriate time range. As a result, the video search apparatus 10 can accurately determine the video section corresponding to the desired video scene even when the target video image is not structurally organized. Further, the video search apparatus 10 calculates the reliability of the determined video section, thereby allowing a user to be aware of the credibility of the video section resulting from the search and thus improving convenience.

### Second Exemplary Embodiment

Next, a second exemplary embodiment of the present disclosure will be described. The video search apparatus 10 according to the present exemplary embodiment is configured substantially similarly to the configuration described in the first exemplary embodiment. On the other hand, the present exemplary embodiment is different from the first exemplary embodiment in terms of the fact that the target video image does not have to be indexed with the event index. Accordingly, in the video search apparatus 10, the above-described search unit 12 is configured differently in the following manner.

In particular, the search unit 12 according to the present exemplary embodiment has a function of searching for an event contained in the scene condition table from the target video image, but this function is realized using, for example, a model using a neural network. In other words, the search unit 12 has a function of searching for video data corresponding to an event from the target video image using a model that learns corresponding video data for each event in advance. In this case, one possible example of the model includes a model that learns a task of predicting a time at which an event occurs and a label with use of data in which a label indicating an event is manually assigned to a certain time in the video image as teacher data. Note that the search unit 12 may search for all the events using one model, or may search for the events using a plurality of models by, for example, preparing a model for each event.

### Third Exemplary Embodiment

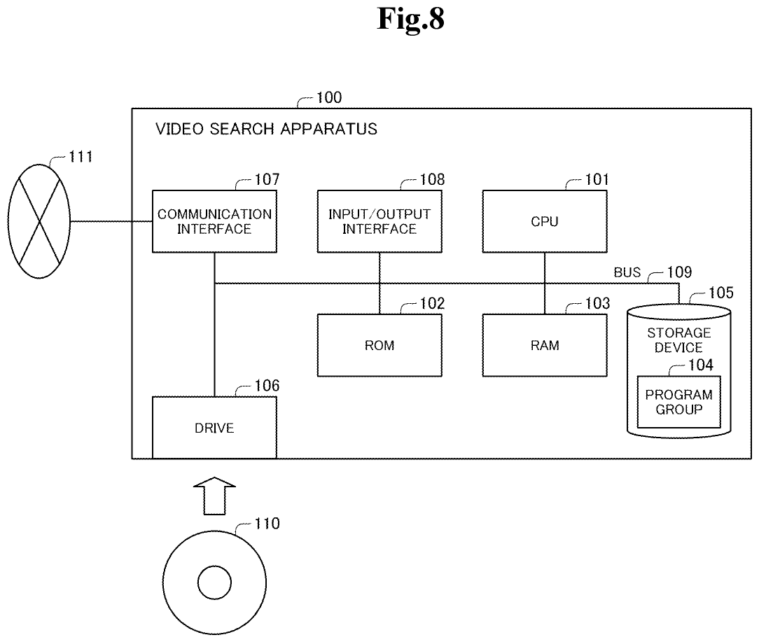

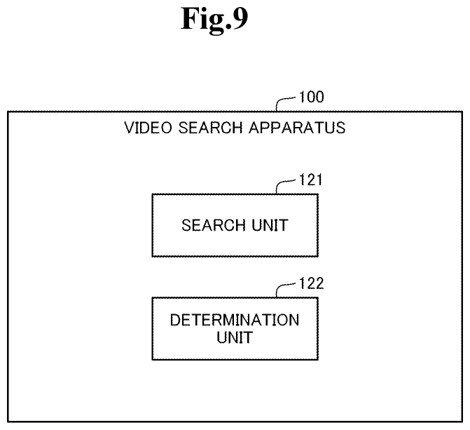

Next, a third exemplary embodiment of the present disclosure will be described with reference to FIGS. 8 and 9. FIGS. 8 and 9 are block diagrams illustrating the configuration of a video search apparatus according to the third exemplary embodiment. Note that the present exemplary embodiment indicates the outline of the configuration of the video search apparatus described in the above-described exemplary embodiments.

First, the hardware configuration of a video search apparatus 100 according to the present exemplary embodiment will be described with reference to FIG. 8. The video search apparatus 100 is configured of a typical information processing apparatus, having a hardware configuration as described below as one example.
Central Processing Unit (CPU) 101 (arithmetic unit)
Read Only Memory (ROM) 102 (storage unit)
Random Access Memory (RAM) 103 (storage unit)
Program group 104 to be loaded to the RAM 103
Storage device 105 storing therein the program group 104
Drive 106 that performs reading and writing on a storage medium 110 outside the information processing apparatus
Communication interface 107 connecting to a communication network 111 outside the information processing apparatus
Input/output interface 108 for performing input/output of data
Bus 109 connecting the constituent elements

Note that FIG. 8 illustrates one example of the hardware configuration of the information processing apparatus that is the video search apparatus 100. The hardware configuration of the information processing apparatus is not limited to that described above. For example, the information processing apparatus may be configured of a part of the configuration described above, such as without the drive 106. Further, the information processing apparatus can, for example, use a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, or a microcontroller, or a combination thereof, instead of the above-described CPU.

Then, the video search apparatus 100 can construct and include a search unit 121 and a determination unit 122 illustrated in FIG. 9 through acquisition and execution of the program group 104 by the CPU 101. Note that the program group 104 is, for example, stored in the storage device 105 or the ROM 102 in advance, and is loaded to the RAM 103 and executed by the CPU 101 as needed. Alternatively, the program group 104 may be provided to the CPU 101 via the communication network 111, or may be stored in the storage medium 110 in advance and read out by the drive 106 and supplied to the CPU 101. However, the above-described search unit 121 and determination unit 122 may be constructed by electronic circuits designed specifically for realizing these units.

The above-described search unit 121 uses scene information including event information including a plurality of events constituting a video scene and time information indicating a time set for the video scene to set a search range of an event in a target video image based on the time information and also search for the event included in the event information from the target video image within the set search range. Then, for example, an occurrence order of the plurality of events is set in the above-described event information, and a time interval between the events is set in the above-described time information. Therefore, the search unit 121 sets the search range in consideration of the temporal relationship between the events, and searches for the events constituting the video scene within this search range.

The above-described determination unit 122 determines a video section in the target video image that corresponds to the scene information targeted for the search based on a result of the search for the event. For example, the determination unit 122 determines the video section containing the searched events or the video section in consideration of the time information.

By being configured in this manner, the present disclosure sets the search range of the event using the time information set in the scene information, thereby being able to search for the plurality of events constituting the desired video scene with an appropriate time range. As a result, the present disclosure can accurately determine the video section corresponding to the desired video scene even when the target video image is structurally organized.

Note that the program described above can be supplied to a computer by being stored on a non-transitory computer-readable medium of any type. Non-transitory computer-readable media include tangible storage media of various types. Examples of non-transitory computer-readable media include a magnetic recording medium (for example, a flexible disk, a magnetic tape, and a hard disk drive), a magneto-optical recording medium (for example, a magneto-optical disk), a CD-Read Only Memory (ROM), a CD-R, a CD-R/W, a semiconductor memory (for example, a mask ROM, a Programmable ROM (PROM), an Erasable PROM (EPROM), a flash ROM, and a Random Access Memory (RAM)). Alternatively, the program may also be supplied to a computer via a transitory computer-readable medium of any type. Examples of transitory computer-readable media include electric signals, optical signals, and electromagnetic waves. A transitory computer-readable medium can supply the program to a computer via a wired communication channel such as an electric wire and an optical fiber, or a wireless communication channel.

While the present disclosure has been described with reference to the exemplary embodiments described above, the present disclosure is not limited to the above-described exemplary embodiments. The form and details of the present disclosure can be changed within the scope of the present disclosure in various manners that can be understood by those skilled in the art. Further, at least one or more function(s) among the functions of the above-described search unit 121 and determination unit 122 may be executed by an information processing apparatus set up at any location in a network and connected therefrom, i.e., may be executed by so-called cloud computing.

### <Supplementary Notes>

The whole or part of the exemplary embodiments disclosed above can be described as, but not limited to, the following supplementary notes. Hereinafter, outlines of the configurations of a video search apparatus, a video search method, and a program according to the present disclosure will be described. However, the present disclosure is not limited to the configurations described below.

### (Supplementary Note 1)

A video search apparatus comprising:
a search unit configured to use scene information including event information including a plurality of events constituting a video scene and time information indicating a time set for the video scene to set a search range of an event in a target video image based on the time information and also search for the event included in the event information from the target video image within the set search range; and
a determination unit configured to determine a video section in the target video image that corresponds to the scene information targeted for the search based on a result of the search for the event.

### (Supplementary Note 2)

The video search apparatus according to supplementary note 1, wherein
the time information includes a time interval between the events included in the event information, and
the search unit searches for a predetermined event included in the event information from the target video image, and also sets the search range of the event in the target video image based on this searched predetermined event and the time interval and further searches for another event included in the event information from the target video image within the set search range.

### (Supplementary Note 3)

The video search apparatus according to supplementary note 2, wherein
the event information includes an occurrence order of the plurality of events, and
the search unit searches for the predetermined event included in the event information from the target video image, and also sets the search range of the event in the target video image based on this searched predetermined event and the time interval and further searches for the other event included in the event information from the target video image within the set search range according to the occurrence order.

### (Supplementary Note 4)

The video search apparatus according to supplementary note 3, wherein
a specific event among the plurality of events is set in the event information as a key event,
the time information includes a time interval in relation to the key event included in the event information for each of the other event(s), and
the search unit searches for the key event included in the event information from the target video image, and also sets the search range of the event in the target video image based on the time interval set in relation to this searched key event and further searches for the other event included in the event information from the target video image within the set search range according to the occurrence order.

### (Supplementary Note 5)

The video search apparatus according to supplementary note 3, wherein
the time information includes a time interval for each interval between events adjacent to each other according to the occurrence order of the events included in the event information, and
each time the predetermined event included in the event information is searched for from the target video image, the search unit sets the search range of the event in the target video image based on the time interval from this searched predetermined event to another event adjacent to the predetermined event according to the occurrence order and further searches for the other event included in the event information from the target video image within the set search range according to the occurrence order.

### (Supplementary Note 6)

The video search apparatus according to any of supplementary notes 1 to 5, wherein
the determination unit determines the video section in the target video image that corresponds to the scene information based on the searched event and the time information.

### (Supplementary Note 7)

The video search apparatus according to any of supplementary notes 1 to 6, wherein
the determination unit calculates reliability of the determined video section based on the events in the event information and the searched event.

### (Supplementary Note 8)

The video search apparatus according to supplementary note 7, wherein
the determination unit calculates the reliability in such a manner that the reliability of the determined video section has a higher value as the number of searched events among the events in the event information increases.

### (Supplementary Note 9)

A video search method comprising:
using scene information including event information including a plurality of events constituting a video scene and time information indicating a time set for the video scene to set a search range of an event in a target video image based on the time information and also search for the event included in the event information from the target video image within the set search range; and
determining a video section in the target video image that corresponds to the scene information targeted for the search based on a result of the search for the event.

### (Supplementary Note 9.1)

The video search method according to supplementary note 9, wherein
the time information includes a time interval between the events included in the event information, and
the video search method further comprising:
searching for a predetermined event included in the event information from the target video image, and also setting the search range of the event in the target video image based on this searched predetermined event and the time interval and further searching for another event included in the event information from the target video image within the set search range.

### (Supplementary Note 9.2)

The video search method according to supplementary note 9.1, wherein
the event information includes an occurrence order of the plurality of events, and
the video search method further comprising:
searching for the predetermined event included in the event information from the target video image, and also setting the search range of the event in the target video image based on this searched predetermined event and the time interval and further searching for the other event included in the event information from the target video image within the set search range according to the occurrence order.

### (Supplementary Note 9.3)

The video search method according to supplementary note 9.2, wherein
a specific event among the plurality of events is set in the event information as a key event,
the time information includes a time interval in relation to the key event included in the event information for each of the other event(s), and
the video search method further comprising:
searching for the key event included in the event information from the target video image, and also setting the search range of the event in the target video image based on the time interval set in relation to this searched key event and further searching for the other event included in the event information from the target video image within the set search range according to the occurrence order.

### (Supplementary Note 9.4)

The video search method according to supplementary note 9.2, wherein
the time information includes a time interval for each interval between events adjacent to each other according to the occurrence order of the events included in the event information, and
the video search method further comprising:
each time the predetermined event included in the event information is searched for from the target video image, setting the search range of the event in the target video image based on the time interval from this searched predetermined event to another event adjacent to the predetermined event according to the occurrence order and further searching for the other event included in the event information from the target video image within the set search range according to the occurrence order.

### (Supplementary Note 9.5)

The video search method according to any of supplementary notes 9 to 9.4, further comprising:
determining the video section in the target video image that corresponds to the scene information based on the searched event and the time information.

### (Supplementary Note 9.6)

The video search method according to any of supplementary notes 9 to 9.5, further comprising:
calculating reliability of the determined video section based on the events in the event information and the searched event.

### (Supplementary Note 9.7)

The video search method according to supplementary note 9.6, further comprising:
calculating the reliability in such a manner that the reliability of the determined video section has a higher value as the number of searched events among the events in the event information increases.

### (Supplementary Note 10)

A program for causing a computer to execute processing to:
use scene information including event information including a plurality of events constituting a video scene and time information indicating a time set for the video scene to set a search range of an event in a target video image based on the time information and also search for the event included in the event information from the target video image within the set search range; and
determine a video section in the target video image that corresponds to the scene information targeted for the search based on a result of the search for the event.

### REFERENCE SIGNS LIST

10 video search apparatus
11 acquisition unit
12 search unit
13 determination unit
16 video storage unit
17 scene condition storage unit
100 video search apparatus
101 CPU
102 ROM
103 RAM
104 program group
105 storage device
106 drive
107 communication interface
108 input/output interface
109 bus
110 storage medium
111 communication network
121 search unit
122 determination unit

1. A video search apparatus comprising:
at least one memory configured to store instructions; and
at least one processor configured to execute instructions to:
use scene information including event information including a plurality of events constituting a video scene and time information indicating a time set for the video scene to set a search range of an event in a target video image based on the time information and also search for the event included in the event information from the target video image within the set search range; and
determine a video section in the target video image that corresponds to the scene information targeted for the search based on a result of the search for the event.

2. The video search apparatus according to claim 1, wherein
the time information includes a time interval between the events included in the event information, and
the at least one processor is configured to execute the instructions to:
search for a predetermined event included in the event information from the target video image, and also set the search range of the event in the target video image based on this searched predetermined event and the time interval and further search for another event included in the event information from the target video image within the set search range.

3. The video search apparatus according to claim 2, wherein
the event information includes an occurrence order of the plurality of events, and
the at least one processor is configured to execute the instructions to:
search for the predetermined event included in the event information from the target video image, and also set the search range of the event in the target video image based on this searched predetermined event and the time interval and further search for the other event included in the event information from the target video image within the set search range according to the occurrence order.

4. The video search apparatus according to claim 3, wherein
a specific event among the plurality of events is set in the event information as a key event,
the time information includes a time interval in relation to the key event included in the event information for each of the other event(s), and
the at least one processor is configured to execute the instructions to:
search for the key event included in the event information from the target video image, and also set the search range of the event in the target video image based on the time interval set in relation to this searched key event and further search for the other event included in the event information from the target video image within the set search range according to the occurrence order.

5. The video search apparatus according to claim 3, wherein
the time information includes a time interval for each interval between events adjacent to each other according to the occurrence order of the events included in the event information, and
the at least one processor is configured to execute the instructions to:
each time the predetermined event included in the event information is searched for from the target video image, set the search range of the event in the target video image based on the time interval from this searched predetermined event to another event adjacent to the predetermined event according to the occurrence order and further search for the other event included in the event information from the target video image within the set search range according to the occurrence order.

6. The video search apparatus according to claim 1, wherein
the at least one processor is configured to execute the instructions to:
determine the video section in the target video image that corresponds to the scene information based on the searched event and the time information.

7. The video search apparatus according to claim 1, wherein
the at least one processor is configured to execute the instructions to:
calculate reliability of the determined video section based on the events in the event information and the searched event.

8. The video search apparatus according to claim 7, wherein
the at least one processor is configured to execute the instructions to:
calculate the reliability in such a manner that the reliability of the determined video section has a higher value as the number of searched events among the events in the event information increases.

9. A video search method comprising:
using scene information including event information including a plurality of events constituting a video scene and time information indicating a time set for the video scene to set a search range of an event in a target video image based on the time information and also search for the event included in the event information from the target video image within the set search range; and
determining a video section in the target video image that corresponds to the scene information targeted for the search based on a result of the search for the event.

10. The video search method according to claim 9, wherein
the time information includes a time interval between the events included in the event information, and
the video search method further comprising:
searching for a predetermined event included in the event information from the target video image, and also setting the search range of the event in the target video image based on this searched predetermined event and the time interval and further searching for another event included in the event information from the target video image within the set search range.

11. The video search method according to claim 10, wherein
the event information includes an occurrence order of the plurality of events, and
the video search method further comprising:
searching for the predetermined event included in the event information from the target video image, and also setting the search range of the event in the target video image based on this searched predetermined event and the time interval and further searching for the other event included in the event information from the target video image within the set search range according to the occurrence order.

12. The video search method according to claim 11, wherein
a specific event among the plurality of events is set in the event information as a key event,
the time information includes a time interval in relation to the key event included in the event information for each of the other event(s), and
the video search method further comprising:
searching for the key event included in the event information from the target video image, and also setting the search range of the event in the target video image based on the time interval set in relation to this searched key event and further searching for the other event included in the event information from the target video image within the set search range according to the occurrence order.

13. The video search method according to claim 11, wherein
the time information includes a time interval for each interval between events adjacent to each other according to the occurrence order of the events included in the event information, and
the video search method further comprising:
each time the predetermined event included in the event information is searched for from the target video image, setting the search range of the event in the target video image based on the time interval from this searched predetermined event to another event adjacent to the predetermined event according to the occurrence order and further searching for the other event included in the event information from the target video image within the set search range according to the occurrence order.

14. The video search method according to claim 9, further comprising:
determining the video section in the target video image that corresponds to the scene information based on the searched event and the time information.

15. The video search method according to claim 9, further comprising:
calculating reliability of the determined video section based on the events in the event information and the searched event.

16. The video search method according to claim 15, further comprising:
calculating the reliability in such a manner that the reliability of the determined video section has a higher value as the number of searched events among the events in the event information increases.

17. A non-transitory computer-readable storage medium storing thereon a program comprising instructions for causing a computer to execute processing to:
use scene information including event information including a plurality of events constituting a video scene and time information indicating a time set for the video scene to set a search range of an event in a target video image based on the time information and also search for the event included in the event information from the target video image within the set search range; and
determine a video section in the target video image that corresponds to the scene information targeted for the search based on a result of the search for the event.
